(19) United States
(12) Patent Application Publication
(10) Pub. No.: US 2023/0304133 A1
(43) Pub. Date: Sep. 28, 2023

(54) CERMET DECORATIVE ITEM

(71) Applicant: The Swatch Group Research and Development Ltd, Marin (CH)

(72) Inventors: Bernard BERTHEVILLE, Sion (CH); Yann FALLET, Savagnier (CH)

(73) Assignee: The Swatch Group Research and Development Ltd, Marin (CH)

(21) Appl. No.: 18/041,707

(22) PCT Filed: Jul. 7, 2021
(86) PCT No.: PCT/EP2021/068836

§ 371 Date: Feb. 15, 2023

(30) Foreign Application Priority Data
Sep. 9, 2020 (EP) 20195335.3

(51) Int. Cl. C22C 29/16; G04B 37/22; C22C 29/12; C22C 29/00; C22C 1/053

(52) U.S. Cl. CPC C22C 29/16; G04B 37/22; C22C 29/12; C22C 29/005; C22C 1/053

(57) ABSTRACT

The invention relates to a decorative item made of a cermet material including by weight between 70 and 97% of a ceramic phase and between 3 and 30% of a metal binder phase, the metal binder comprising at least one element or its alloy selected from the list consisting of ruthenium, rhodium, palladium, osmium, iridium, platinum, gold and silver, the ceramic phase including a nitride phase and optionally an oxide and/or oxynitride phase, said nitride phase being present in relation to the total weight of the cermet material in a percentage between 70 and 97% and said oxide and/or oxynitride phase in a percentage between 0 and 15%.

The present invention also relates to the method implemented to produce this item.

### TECHNICAL FIELD

The present invention relates to a decorative item and in particular to an external timepiece component, made of a cermet type material with a ceramic phase comprising a nitride and a metallic phase comprising a precious metal.

### PRIOR ART

Nitride-based coloured cermets contain an allergenic metal binder such as nickel or cobalt. In order to produce parts that may be in contact with the skin such as watch cases or jewellery, it is imperative to develop compositions eliminating the use of binders comprising these elements.

Furthermore, the cermets used for specific applications such as watch cases must have a very good scratch resistance, that is to say a hardness greater than 1,000 HV. This requires reducing the amount of metal binder while controlling the wettability between the metal binder and the ceramic phase, a poor wettability resulting in a reduction of the density on the final product and thereby of the hardness. In particular, producing a yellow TiN-based coloured cermet, not containing nickel and cobalt and with good final properties by power metallurgy and by conventional liquid-state sintering is difficult. This is mainly due to the very high melting temperature of titanium nitride that is 2,930° C. and to its poor wettability with metal binders during liquid-state sintering. It follows that the cermet has at the end of sintering a high porosity that results in a reduction of the hardness.

Apart from the hardness, the percentages between the various phases must also be adjusted to obtain a good tenacity and the desired colour nuance on the final product.

### SUMMARY OF THE INVENTION

The object of the present invention is to overcome the drawbacks cited above proposing a cermet with an optimised composition to meet the following criteria:
eliminate the use of allergenic elements such as nickel or cobalt,
be able to be densified by liquid phase sintering, under low pressure (conventional sintering),
have a minimum hardness of 500 HV30, preferably minimum of 550 HV30 and more preferably minimum of 1,000 HV30 for an application requiring a very good scratch resistance, while having a sufficient tenacity with, preferably, a Kᵢc greater than or equal to 2.8 MPa·m^{1/2}
have colour nuances ranging from white to yellow marked with a high metal shine (65<L*≤80).

To this end, the present invention proposes a decorative item made of a cermet material including by weight between 70 and 97% of a ceramic phase and between 3 and 30% of a metal binder phase, the metal binder comprising at least one element or its alloy selected from the list consisting of ruthenium, rhodium, palladium, osmium, iridium, platinum, gold and silver, the ceramic phase including a nitride phase and optionally an oxide and/or oxynitride phase, said nitride phase being present in relation to the total weight of the cermet material in a percentage between 70 and 97% and said oxide and/or oxynitride phase in a percentage between 0 and 15%.

In particular, for the production of a TiN-based yellow colour cermet by powder metallurgy and by conventional liquid-state sintering, it is proposed to add an oxide and/or an oxynitride that makes it possible to improve the densification and increase the hardness.

The cermet material thus developed has after polishing a metal shine greater than that of cermets using as metal binder nickel or cobalt and comparable with that observed in stainless steels (L*=75-80). These precious cermets have hardnesses that may reach up to 1,250 HV30 and they have sufficient tenacities for the production of external parts. Furthermore, they can be shaped by conventional powder metallurgy processes such as pressing or injection in order to obtain “near-net shape” 3D parts.

Other features and advantages of the present invention will become apparent in the following description of a preferred embodiment, given by way of non-limiting example with reference to the appended drawings.

### BRIEF DESCRIPTION OF THE FIGURES

FIG. 1 shows a timepiece comprising a middle made with the cermet type material according to the invention.

FIG. 2 shows an optical microscopic image of the cermet type material according to the invention with a composition by weight of 92% TiN and 8% Pd.

FIG. 3 shows an optical microscopic image of the cermet type material according to the invention with a composition by weight of 84.6% TiN-9.4% ZrO₂ and 6% Pd.

### DETAILED DESCRIPTION

The present invention relates to a decorative item made of a cermet type material including (consisting of) by weight between 70 and 97% of a ceramic phase and between 3 and 30% of a metal binder phase. Preferably, the cermet includes (consists of) by weight between 75 and 97% of the ceramic phase and between 3 and 25% of the metal binder phase. More preferably, the cermet includes (consists of) by weight between 78 and 96% of the ceramic phase and between 4 and 22% of the metal binder phase. The metal binder is selected from the list of elements comprising ruthenium, rhodium, palladium, osmium, iridium, platinum, gold and silver. It may also concern a combination of a plurality of said elements or of an alloy of one of said elements such as, for example, Au-3N, Au-5N. The ceramic phase comprises a nitride phase and optionally an oxide and/or oxynitride phase. In other words, the ceramic phase consists of a nitride phase and optionally of an oxide and/or oxynitride phase. The object of the oxide and/or oxynitride phase is to increase the mechanical properties. When it is present, the oxide and/or oxynitride phase is minority in relation to the nitride phase. More specifically, in relation to the total weight of the cermet, the nitride phase is present in a percentage between 70 and 97% and the oxide and oxynitride phase in a percentage between 0 and 15%. The nitrides are selected from the non-exhaustive list comprising Al, Ti, Si, Mn, Zr, Hf, Ta, Nb, V, Cr, Mo, W and B nitrides and a combination of nitrides of these elements. The oxides and oxynitrides are selected from the non-exhaustive list comprising respectively Al, Ti, Si, Mn, Zr, Hf, Ta, Nb, V, Cr, Mo, W and B oxides and oxynitrides and a combination of oxides and oxynitrides of these elements.

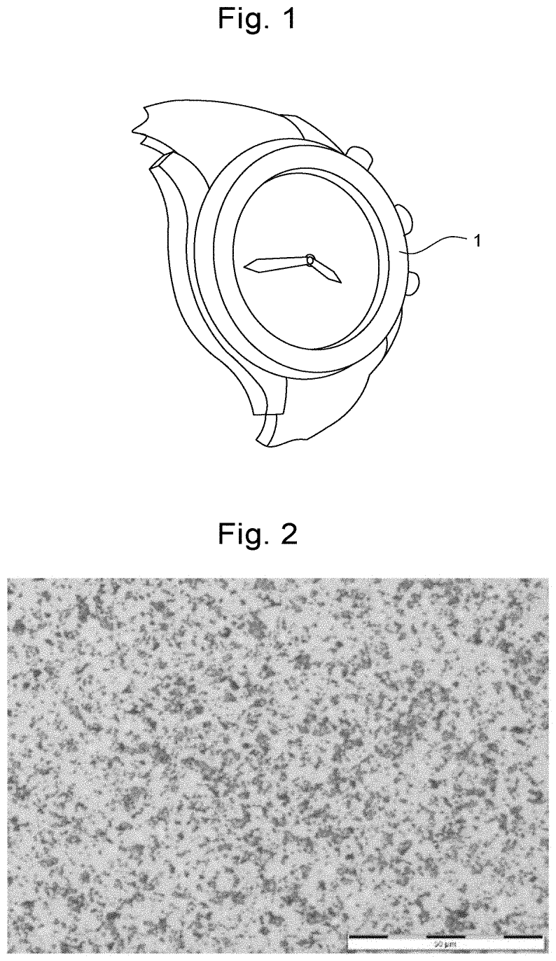

The decorative item may be a constituent element of watches, pieces of jewellery, bracelets, etc. In the watchmaking field, this item may be an external part such as a middle, a back, a bezel, a push-piece, a bracelet link, a dial, a hand, a dial index, etc. By way of illustration, a middle 1 made with the cermet type material according to the invention is shown in FIG. 1.

The cermet item is produced by sintering starting from a mixture of ceramic and metal powders. The manufacturing method includes steps of:
a) Producing a mixture with the various powders and this possibly in a wet environment. The starting powders have preferably a d50 less than 10 μm, and more preferably between 2 and 5 μm. The mixture may possibly be produced in a mill, which reduces the d50 of the particles of the powder to a size in the order of the micron, or even less than the micron after milling. This mixture includes by weight between 70 and 97%, preferably between 75 and 97%, more preferably between 78 and 96%, of the ceramic powder and between 3 and 30%, preferably between 3 and 25%, more preferably between 4 and 22% of the metal powder. The ceramic powder includes nitrides and optionally oxides and/or oxynitrides. More specifically, in relation to the total weight of powders, the nitrides are present in a percentage between 70 and 97%, preferably between 75 and 97%, more preferably between 78 and 96%, and the oxides and/or oxynitrides in a percentage between 0 and 15%. The nitrides are selected from the non-exhaustive list comprising Al, Ti, Si, Mn, Zr, Hf, Ta, Nb, V, Cr, Mo, W and B nitrides and a combination of nitrides of these elements. Advantageously, the nitrides are selected from Ti, Ta, Nb, Zr nitrides and a combination of these nitrides. The oxides and oxynitrides are selected from the non-exhaustive list comprising respectively Al, Ti, Si, Mn, Zr, Hf, Ta, Nb, V, Cr, Mo, W and B oxides and oxynitrides and a combination of oxides and oxynitrides of these elements. Advantageously, the oxides and oxynitrides are selected from Zr or Nb oxides and oxynitrides. The metal powder is selected from the list of metal elements comprising ruthenium, rhodium, palladium, osmium, iridium, platinum, gold, silver, a combination of a plurality of said elements and an alloy of one of said elements. Thus, preferably, gold is alloyed with at least one element selected from Cu, Ag, Pd, C et N. Advantageously, the metal powder mainly includes palladium, platinum, silver or gold alloyed with copper and/or silver. It may, apart from impurities, consist entirely of platinum, palladium, silver or gold alloyed with copper and/or silver. By way of example, the powder mixture may include one of the following distributions by weight:
between 78 and 96% of TiN and between 5 and 20% of Pd or Pt,
between 80 and 90% of TiN and between 10 and 20% of Ag,
between 75 and 85% of TiN and between 15 and 25% of an Au alloy,
between 80 and 90% of NbN and between 10 and 20% of an Au alloy,
between 85 and 95% of NbN or TaN and between 5 and 15% of Pd or Pt,
between 80 and 90% of TiN, between 5 and 15% of ZrO₂, and between 3 and 10% of Pd or of an Au alloy,
between 75 and 85% of TiN, between 5 and 15% of ZrN, and between and 15% of an AU alloy,
between 70 and 80% of NbN, between 5 and 20% of Nb₂O₅, and between 5 and 15% of Pt.
b) Optionally, a second mixture comprising the mixture cited above and an organic binder system (paraffin, polyethylene, etc.) can be made.
c) Forming a blank by giving to the mixture the shape of the desired item, for example, by injection (Ceramic Injection Moulding), or by pressing.
d) Sintering the blank in an inert atmosphere or in nitrogen or in a vacuum at a temperature between 1,100 and 2,100° C., preferably between 1,400 and 1,750° C., for a period between 30 minutes and 20 hours, preferably between 30 minutes and 2 hours. This step may be preceded by a step of debinding in a range of temperatures between 200 and 800° C. if the mixture includes an organic binder system.

The blank thus obtained is cooled and polished. It may also be machined before polishing to obtain the desired item.

The item from the manufacturing method includes the ceramic phase and the metallic phase in percentages by weight close to those of the starting powders. However, it is not possible to rule out slight variations of compositions and percentages between the base powders and the material from the sintering following, for example, contaminations or transformations during sintering. For example, oxynitrides may be formed in situ if the starting powder contains both nitrides and oxides of the same element. The metal and ceramic phases are homogeneously distributed within the cermet material.

The item has a CIELAB colour space (in accordance with the standards CIE no. 15, ISO 7724/1, DIN 5033 Teil 7, ASTM E-1164) with a lightness L* component, representative of how the material reflects light, of minimum 60, preferably of minimum 65 and more preferably of minimum 75. The colour variations range from white corresponding to the steel colour to a slightly yellow tinged colour to a significantly yellow colour. More specifically, for a white colour item, the a* component is between −3 and +3 and the b* component is between −3 and +3. For a colour between white and yellow, the a* component is between 0 and +3 and the b* component between 0 and +10. For a yellow colour, the a* component is between 0 and +5 and the b* component between +20 and +30.

The ceramic material has a Vickers hardness measured under a load of 30 kg (HV30) between 500 and 1,300, preferably between 550 and 1,250, depending on the types and on the percentages of the constituents. Advantageously, it has a hardness greater than 1,000 Vickers for the external parts requiring a very high scratch resistance. It has a tenacity Kᵢc of minimum 2 MPa·m^{1/2}, preferably of minimum 2.8 MPa·m^{1/2}, the tenacity being determined based on measurements of the lengths of cracks at the four ends of the diagonals of the hardness indentation according to the formula:

$${K}_{1 C} = 0.0319 \frac{P}{a {l}^{1 / 2}}$$

where P is the load applied (N), a is the half-diagonal (m) and/is the measured crack length (m).

Table 1 hereinafter contains various examples of cermets according to the invention. The values in italics and bold meet the criteria for a hardness greater than 1,000 Vickers, a tenacity greater than 2.8 MPa·m^{1/2}, an L* index greater than 75 or a b* index greater than 25 for a very yellow colour.

13 mixtures of powders of distinct compositions were prepared in a mill in the presence of a solvent. The mixtures were produced without adding organic binders. After drying, they were shaped by uniaxial pressure and sintered in a vacuum, or in dynamic partial pressure of 60 mbar of argon or of nitrogen and at a temperature that is dependent on the powder composition. After sintering, the samples were flat polished in order to accurately measure the mechanical properties and the colour indices.

HV₃₀ hardness measurements were made on the surface of the samples and the tenacity was determined based on the hardness measurements as described above.

The Lab colorimetric values were measured on the polished samples with a KONICA MINOLTA CM-5 spectrophotometer under the following conditions: SCI (specular component included) and SCE (specular component excluded) measurements, inclination of 8°, 8 mm diameter MAV measurement zone.

It is apparent from these tests that hardnesses greater than 1,000 Vickers are obtained for the compositions with 84.6% TiN-9.4% ZrO₂-6% Pd (test no. 3), 89.5% NbN-10.5% Pd (test no. 4), 89.5% TaN-10.5% Pd (test no. 5), 85% TiN-15% Pt (test no. 6), 75% NbN-15% Nb₂O₅-10% Pt (test no. 8), 84.6% TiN-9.4% ZrO₂-6% Au3N (test no. 9), 86% NbN-10.5% Au-3.5% Cu (test no. 12). These same compositions have a tenacity greater than 3.3 MPa·m^{1/2}.

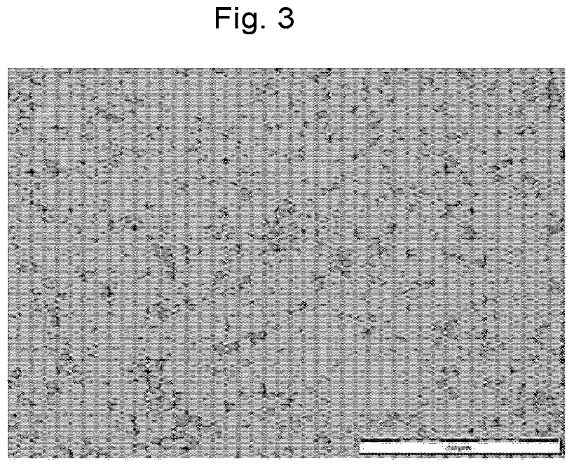

In particular, by comparing tests no. 2 (92% TiN, 8% Pd) and no. 3 (84.6% TiN-9.4% ZrO₂-6% Pd), a clear increase of the hardness from 590 to 1,050 Vickers is observed, when an oxide, in the example ZrO₂, is added. The oxide makes it possible to improve the densification and acts as reinforcement for increasing the mechanical properties. In FIG. 3, the reduction of the porosity is observed (dark spots) when the oxide is added for sample no. 3 compared to sample no. 2 of FIG. 2. Thus, the hardness is almost doubled without significantly impacting the tenacity. Likewise, by comparing tests no. 7 and no. 8, an increase of the hardness and of the tenacity is observed with the addition of Nb₂O₅.

Furthermore, the nuance with NbN and alloyed gold (test no. 12) makes it possible to combine hardness values greater than 1,000 Vickers, with a tenacity greater than 4.5 MPa·m^{1/2} and a lightness L* value close to 80, i.e. identical to the lightness measured on polished stainless steels.

When the platinum in sample no. 6 is used as binder instead of the palladium of sample no. 1, it is observed on these nuances including 85% of TiN, an increase of the hardness that reaches the maximum value of 1,192 Vickers.

TABLE 1

| | | | Size | Sintering | | Mechanical properties | | | | |
|---|---|---|---|---|---|---|---|---|---|---|
| | Composition (wt) | | d50 | T | time | | K1C | | | |
| No. | Nitride/Oxide | Binder | (μm) | (° C.) | (min) | HV30 | (MPa · m½) | [symbol] | [symbol] | [symbol] |
| (1) | 85% TiN | 15% Pd | 0.63 | 1,450 | 90 | 657 | [symbol] | [symbol] | 3.39 | 24.33 |
| | | | | 1,500 | 90 | 701 | [symbol] | 73.1 | 3.07 | 23.92 |
| | | | | 1,600 | 90 | 863 | [symbol] | 74.5 | 1.17 | [symbol] |
| (2) | 92% TiN | 8% Pd | 0.67 | 1,600 | 90 | 590 | [symbol] | 69.27 | 2.07 | [symbol] |
| (3) | 84.6% TiN-9.4% ZrO₂ | 6% Pd | 0.87 | 1,600 | 90 | [symbol] | [symbol] | 72.43 | 1.59 | [symbol] |
| | | | | 1,650 | 90 | [symbol] | [symbol] | 72.94 | 1.48 | [symbol] |
| (4) | 89.5% NbN | 10.5% Pd | 0.93 | 1,550 | 60 | [symbol] | [symbol] | [symbol] | 0.76 | 5.90 |
| | | | | 1,600 | 90 | [symbol] | [symbol] | [symbol] | 0.37 | 4.32 |
| (5) | 89.5% TaN | 10.5% Pd | 1.18 | 1,550 | 60 | [symbol] | [symbol] | 70.54 | 0.55 | −0.36 |
| | | | | 1,600 | 90 | [symbol] | [symbol] | 70.43 | 0.38 | 0.87 |
| (6) | 85% TiN | 15% Pt | 0.62 | 1,600 | 45 | [symbol] | [symbol] | 72.88 | 3.19 | 24.95 |
| | | | | 1,700 | 35 | [symbol] | [symbol] | 72.14 | 2.77 | 23.80 |
| (7) | 89.1% NbN | 10.9% Pt | 0.97 | 1,600 | 90 | 909 | 1.4 | [symbol] | 0.49 | 5.64 |
| (8) | 75% NbN-15% Nb₂O₅ | 10% Pt | 0.60 | 1,600 | 90 | [symbol] | [symbol] | 72.85 | 0.53 | 4.12 |
| (9) | 84.6% TiN-9.4% ZrO₂ | 6% Au-3N* | 0.83 | 1,550 | 60 | [symbol] | [symbol] | 72.07 | 1.43 | [symbol] |
| | | | | 1,600 | 90 | [symbol] | [symbol] | 71.68 | 1.68 | [symbol] |
| (10) | 80% TiN | 15% Au-5% Cu | 1.04 | 1,500 | 90 | 540 | [symbol] | 72.1 | 3.41 | [symbol] |
| | | | | 1,600 | 90 | 723 | [symbol] | 72.8 | 3.09 | [symbol] |
| (11) | 80% TiN-10% ZrN | 7.5% Au-2.5% Cu | 0.80 | 1,400 | 90 | 596 | [symbol] | 65.0 | 7.77 | 22.28 |
| | | | | 1,450 | 90 | 631 | [symbol] | 65.5 | 7.44 | 22.49 |
| | | | | 1,500 | 90 | 729 | [symbol] | 68.0 | 6.59 | 23.51 |
| (12) | 86% NbN | 10.5% Au-3.5% Cu | 0.81 | 1,400 | 90 | [symbol] | [symbol] | [symbol] | 1.03 | 5.70 |
| | | | | 1,450 | 90 | [symbol] | [symbol] | [symbol] | 1.00 | 5.79 |
| | | | | 1,500 | 90 | [symbol] | [symbol] | [symbol] | 0.80 | 5.21 |
| (13) | 85% TiN | 15% Ag | 0.80 | 1,500 | 90 | 678 | [symbol] | 69.7 | 4.39 | [symbol] |

*Au-3N: 75% Au-12.5% Ag-12.5% Cu + additives

1. A decorative item comprising a cermet material comprising by weight between 70 and 97% of a ceramic phase and between 3 and 25% of a metal binder phase, the metal binder comprising at least one element or its alloy selected from the group consisting of ruthenium, rhodium, palladium, osmium, iridium, platinum, gold and silver, the ceramic phase including a nitride phase and optionally an oxide and/or oxynitride phase, said nitride phase being present in relation to the total weight of the cermet material in a percentage between 70 and 97% and said oxide and/or oxynitride phase in a percentage between 0 and 15%.

2. The item according to claim 1, wherein the metal binder phase is present in a percentage by weight between 4 and 22% and the ceramic phase is present in a percentage by weight between 78 and 96%, said nitride phase being present in relation to the total weight of the cermet material in a percentage between 78 and 96% and said oxide and/or oxynitride phase in a percentage between 0 and 15%.

3. The item according to claim 1, wherein the nitride phase comprises at least one nitride selected from the group consisting of Al, Ti, Si, Mn, Zr, Hf, Ta, Nb, V, Cr, Mo, W and B nitrides.

4. The item according to claim 3, wherein the nitrides are selected from Al, Si, Ti, Ta, Nb and Zr nitrides.

5. The item according to claim 1, wherein the oxides and oxynitrides are selected from the group consisting of Al, Ti, Si, Mn, Zr, Hf, Ta, Nb, V, Cr, Mo, W and B oxides and oxynitrides and a combination of oxides and oxynitrides of these elements.

6. The item according to claim 5, wherein the oxides and oxynitrides are selected from Al, Si, Ti, Ta, Nb and Zr oxides and oxynitrides.

7. The item according to claim 6, wherein the ceramic phase consists of a Ti nitride phase and of a Zr oxide phase.

8. The item according to claim 6, wherein the ceramic phase consists of an Nb nitride phase and of an Nb oxide phase.

9. The item according to claim 1, wherein the metal binder phase consists, apart from impurities, of palladium, platinum, silver or alloyed gold.

10. The item according to claim 1, wherein the metal binder phase includes a gold alloy comprising at least one element selected from copper, silver, palladium and nitrogen.

11. The item according to claim 1, wherein the item has a Vickers hardness, HV₃₀, between 500 and 1,300.

12. The item according to claim 1, wherein the item has a Vickers hardness, HV₃₀, greater than 1,000 when:
the ceramic phase comprises Ti nitrides and Zr oxides and the metal binder phase comprises Pd or an Au alloy,
the ceramic phase comprises Ta or Nb nitrides and the metal binder phase comprises Pd,
the ceramic phase comprises Ti nitrides and the metal binder phase comprises Pt,
the ceramic phase comprises Nb nitrides, Nb oxides and the metal binder phase comprises Pt,
the ceramic phase comprises Nb nitrides and the metal binder phase comprises an Au alloy.

13. The item according to claim 1, wherein the item has a tenacity Kᵢc greater than or equal to 2.8 MPa·m^{1/2}.

14. The item according to claim 1, wherein the item has, in a CIELAB colour space, an L* component of minimum 60.

15. The item according to claim 1, wherein the item has a yellow colour and has, in a CIELAB colour space, an a* component between 0 and +5 and a b* component between +20 and +30.

16. The item according to claim 1, wherein the item has a white colour and has, in a CIELAB colour space, an a* component between −3 and +3 and a b* component between −3 and +3.

17. The item according to claim 1, wherein the item has a colour between white and yellow and has, in a CIELAB colour space, an a* component between 0 and +3 and a b* component between 0 and +10.

18. The item according to claim 1, wherein the item is an external timepiece component selected from the group consisting of a middle, a back, a bezel, a push-piece, a bracelet link, a dial, a hand and a dial index.

19. A method for manufacturing a decorative item comprising, in the following order:
a) producing a mixture with a ceramic powder comprising nitrides and optionally oxides and/or oxynitrides and a metal binder powder comprising at least one element or its alloy selected from the group consisting of ruthenium, rhodium, palladium, osmium, iridium, platinum, gold and silver,
b) forming a blank giving to said mixture the shape of the item,
c) sintering the blank at a temperature between 1,100 and 2,100° C.,
wherein the ceramic powder is present in a percentage by weight between 70 and 97%, and the powder of the metal binder is present in a percentage by weight between 3 and 25%.

20. The method according to claim 19, wherein the mixture of the producing a) comprises one of the following distributions:
between 78 and 96% of TiN and between 4 and 22% of Pd or Pt,
between 80 and 90% of TiN and between 10 and 20% of Ag,
between 75 and 85% of TiN and between 15 and 25% of an Au alloy,
between 80 and 90% of NbN and between 10 and 20% of an Au alloy,
between 85 and 95% of NbN or TaN and between 5 and 15% of Pd or Pt,
between 80 and 90% of TiN, between 5 and 15% of ZrO₂, and between 3 and 10% of Pd or of an Au alloy,
between 75 and 85% of TiN, between 5 and 15% of ZrN, and between 5 and 15% of an AU alloy,
between 70 and 80% of NbN, between 5 and 20% of Nb₂O₅, and between 5 and 15% of Pt.

21. The method according to claim 19, wherein the forming b) is performed by pressing or injection.
